(19) United States
(12) Patent Application Publication
(10) Pub. No.: US 2010/0119663 A1
(43) Pub. Date: May 13, 2010

(54) CANDY COMPOSITION WITH FIBRE-CONTAINING CENTREFILL

(76) Inventors: Sarah Marshall, Berkshire (GB); Kerry Phillips, Wiltshire (GB); Nathalie Montaigne, Linselles (FR)

Correspondence Address: CANTOR COLBURN, LLP, 20 Church Street, 22nd Floor, Hartford, CT, 06103, US

(21) Appl. No.: 12/526,721

(22) PCT Filed: Feb. 25, 2008
(86) PCT No.: PCT/GB2008/000626

§ 371 Date: Dec. 9, 2009

(30) Foreign Application Priority Data
Feb. 23, 2007 (GB) 0703581.9

(51) Int. Cl. A23G 3/54; A23G 3/36; A23L 1/308; A23P 1/10

(52) U.S. Cl. 426/103; 426/89; 426/515

(57) ABSTRACT

The invention provides a number of centrefilled confectionery compositions, in which the centrefill comprises at least 1% by weight dietary fibre, and the confectionery shell (which may be jelly candy, chewy candy, or hard boiled candy) is substantially free of dietary fibre. In the case of a shell of jelly candy or chewy candy, the shell should additionally comprise gelatin. In addition, the invention provides a centrefilled confectionery composition comprising at least 20% by weight of centrefill, wherein the centrefill comprises at least 1% by weight of dietary fibre. The invention further provides the use of a centrefill comprising dietary fibre in a confectionery composition comprising sugar alcohols, to offset the laxative effect of the sugar alcohols; the use of dietary fibre in a centrefill to improve the product integrity of a centrefilled confectionery composition; and a method for manufacturing a centrefilled confectionery composition involving co-deposition of two syrups into mould cavity, one of the syrups being substantially free from dietary fibre and forming the confectionery shell, with the other syrup comprising dietary fibre and forming the centrefill.

This invention relates to the formulation of confectionery compositions. More specifically, it relates to confectionery compositions having a centrefill containing dietary fibre.

It is known for certain confectionery compositions, such as hard-boiled candies, jelly candies and chewy candy, to contain a ‘centrefill’ (which may be liquid, e.g. a syrup, but is usually a gel or paste) encased within a shell. This centrefill provides a pleasing sensation when it is released into a consumer's mouth, either by biting into the confectionery composition, or by the consumer allowing the shell to dissolve. Additionally, the centrefill may have a flavour (or other discernable property, such as acidity or cooling effect) that is noticeably different to that of the shell, further adding to the pleasurable experience on consumption as a result in the contrast of tastes and mouthfeel. Such centrefilled confectionery compositions are commonly produced by co-depositing high temperature solutions of the shell material and the centrefill material into a mould (such as an impression formed in a starch tray). As the materials cool, the shell material solidifies to form a shell fully enclosing the centrefill.

The potential benefit of the centrefill is limited by the need to ensure product integrity during packaging, storage and transport of the confectionery, so that the centrefill remains enclosed within the shell until the composition is eaten. To date, efforts in this regard have concentrated on ensuring that the centrefill is deposited in the centre of the mould cavity, and controlling the quantity of centrefill relative to that of the shell material, so that the shell exceeds the required minimum thickness (and hence the required strength) at all points around the centrefill. Typically, the centrefill forms between 10-20% of the total weight of the confectionery composition. However, it is desirable to increase the size of the centrefill relative to that of the shell, in order to provide a more noticeable differentiation of taste and mouthfeel when the consumer eats the confectionery.

In recent years, concern has arisen that consumption of sugar is associated with health risks, particularly in relation to increased risk of obesity and/or dental caries. There is therefore a desire for confectionery compositions which contain reduced levels of sugar.

One class of sweeteners which has found widespread use in the replacement of sugars in confectionery is sugar alcohols. These are non-cariogenic, have very low calorific values, and have sweetness levels comparable to those of common sugars. As such, sugar alcohols can frequently be used as a direct replacement for sugars in confectionery compositions, thereby avoiding many of the health risks associated with sugar-based confectionery.

One problem with the use of sugar alcohols in confectionery is the laxative effect thereof (see e.g. “Polyols in confectionery: the route to sugar-free, reduced sugar and reduced calorie confectionery”, Zumbé et al., British Journal of Nutrition, 2001, 85, Suppl. 1, S31-S45). This is obviously dependent on the quantity of sugar alcohol consumed, but may be particularly prevalent in children, due to their smaller average body mass than adults. Given that children are some of the main consumers of confectionery, and that the laxative effects of sugar alcohols are likely to be particularly distressing for children, there is therefore a need for confectionery compositions which are low in sugar or sugar-free (to minimise the risks of obesity and dental caries) but in which the laxative effect of sugar alcohols is reduced or absent.

The present invention has been conceived with the above problems in mind.

According to a first aspect of the present invention there is provided a jelly candy composition or a chewy candy composition having a centrefill comprising at least 1% by weight dietary fibre and an outer jelly candy or chewy candy layer encasing the centrefill, wherein the outer jelly candy or chewy candy layer comprises gelatin and is substantially free of dietary fibre.

Jelly candies, also known as gummy candies, are a popular confectionery snack, since they combine a desirable chewing sensation with a sweet flavour. Jelly candies have traditionally been manufactured using sugars or sugar-free bulk sweeteners together with a gelling agent such as gelatin.

‘Chewy candy’ as used herein refers in the art to a particular type of chewable candy which is similar to jelly candy but usually contains additional fat and emulsifier and includes crystalline sugars or sugar-free bulk sweeteners, within a bulk amorphous phase. It may also be aerated by up to 20%.

Gelatin is a common gelling agent in food, and particularly in gummy candies, as the ‘long’, springy texture of the resulting jelly is preferred by consumers over the ‘shorter’ texture of jellies made with other gelling agents such as pectin. However, it has been found that the addition of dietary fibre, and particularly of hydrocolloids, to a gelatin solution can cause disruption of this gelatin texture, and reduction in the strength of the gel, in the resulting jelly. The applicants have found that the incorporation of a centrefill comprising dietary fibre into a jelly candy or chewy candy shell which comprises gelatin but remains substantially free from dietary fibre, produces a jelly candy or chewy candy confectionery composition having a number of benefits, but in which the jelly candy or chewy candy still has the desired texture and strength.

In this context, ‘substantially free from’ means that any fibre present in the jelly candy or chewy candy shell layer is at a sufficiently low level that it will not disrupt the texture of the gelatin. The amount of fibre necessary to disrupt the gelatin structure will depend on the exact fibre used, but may be readily determined by observing the strength of the gel at increasing levels of fibre, and noting the point at which the gel softens. For example, it is possible to incorporate no more than 0.2% by weight pectin in a jelly candy layer to promote gelling during deposition without disrupting the gelatin texture. Similarly it is possible to incorporate up to 1-2% starch in a jelly candy layer. Where both pectin and starch are present, however, the amount of each would need to be reduced.

In one embodiment, therefore, ‘substantially free from’ means that the jelly candy or chewy candy shell layer contains no more than 2% by weight of fibre. Alternatively, ‘substantially free from’ may mean that the jelly candy or chewy candy shell layer contains no more than 1% by weight, or no more than 0.5% by weight, or no more than 0.2% by weight of fibre.

According to a second aspect of the present invention, there is provided a hard boiled candy composition having a centrefill comprising at least 1% by weight dietary fibre and an outer hard boiled candy layer encasing the centrefill, wherein the outer hard boiled candy layer is substantially free of dietary fibre.

As used herein, ‘hard boiled candy’ refers to an amorphous glassy candy produced by heating a syrup of sugar (or suitable sugar-free bulk sweetener) to drive off most of the water, as is well known in the art.

It has been found that the addition of dietary fibre, and particularly of hydrocolloids, to the hard candy syrup leads to an unacceptable product. It is thought that the absence of water in the cooked syrup prevents hydration of the fibres, which clump together producing lumps in the syrup and hence disruption of the desired glassy appearance and texture. Furthermore, during cooking of the syrup these fibres will tend to burn, producing undesirable flavours. The applicants have found that the incorporation of a centrefill comprising dietary fibre into a hard boiled candy shell which remains substantially free from dietary fibre, produces a hard boiled, candy confectionery composition having a number of benefits, but in which the hard boiled candy still has the desired texture and appearance, without undesirable flavours.

In this aspect of the invention, ‘substantially free from’ has the equivalent meaning to that in the first aspect of the invention, namely that the level of fibre present should be sufficiently low that it does not produce the problems described above.

In one embodiment, therefore, ‘substantially free from’ means that the hard-boiled candy shell layer contains no more than 2% by weight of fibre. Alternatively, ‘substantially free from’ may mean that the hard-boiled candy shell layer contains no more than 1% by weight, or no more than 0.5% by weight, or no more than 0.2% by weight of fibre.

According to a third aspect of the present invention, there is provided the use of a centrefill comprising dietary fibre in a confectionery composition comprising one or more sugar alcohols, in order to offset the laxative effect of the one or more sugar alcohols.

According to a fourth aspect of the present invention, there is provided a centrefilled confectionery composition comprising at least 20% by weight of centrefill, wherein the centrefill comprises at least 1% by weight of dietary fibre.

It was previously believed that the proportion of centrefill should be maintained below 20% in order to minimise the risk of the centrefill leaking through the shell of the confectionery composition. However, it has surprisingly been found that the use of dietary fibre in the centrefill reduces the risk of leakage of the centrefill. This allows the incorporation of a greater proportion of centrefill in the confectionery composition, with correspondingly thinner walls of the shell, without significantly affecting the structural integrity of the product. Without wishing to be bound by theory, it is believed that this effect is produced as a result of the increase in viscosity of the centrefill caused by the incorporation of dietary fibre therein.

The confectionery shell of the centrefilled confectionery composition may comprise jelly candy, chewy candy, or hard-boiled candy.

The centrefill may be a liquid (such as a viscous syrup) or a low- or high-viscosity gel.

In one embodiment, the centrefill forms at least 25% by weight of the centrefilled confectionery composition. Alternatively, the centrefill may form at least 30%, at least 40% or at least 50% by weight of the centrefilled confectionery composition.

According to a fifth aspect of the present invention, there is provided the use of dietary fibre in a centrefill syrup to improve the product integrity of a centrefilled confectionery composition.

According to a sixth aspect of the invention, there is provided a method for manufacturing a centrefilled confectionery composition, comprising preparing separately a first syrup which is substantially free of dietary fibre, and a second syrup comprising dietary fibre, and co-depositing the first and second syrups into a mould cavity such that on cooling the first syrup forms a shell extending around the inner surface of the mould cavity and containing the second syrup.

In one embodiment, the second syrup comprises between 1 and 15% dietary fibre.

In all aspects of the present invention, the centrefill may be, according to one embodiment, a semi-liquid or low viscosity gel. According to an alternative embodiment, the centrefill may be a rigid or high-viscosity gel. In a further embodiment, the viscosity of the centrefill is greater than 900 mPas, as measured using a Brookfield viscometer.

In the following embodiments, references to centrefilled confectionery compositions include the centrefilled jelly candy or chewy candy compositions of the first aspect of the invention and the centrefilled hard boiled candy compositions of the second aspect of the invention as well as the centrefilled confectionery composition of the fourth aspect of the invention, and those referred to in the third, fifth and sixth aspects of the invention.

In one embodiment, the centrefill comprises between 1 and 15% by weight soluble dietary fibre. In addition, the centrefill may comprise up to 30% insoluble dietary fibre, or may be free from insoluble dietary fibre. In a further embodiment, the centrefilled confectionery composition comprises one or more sugar alcohols, and the centrefill comprises sufficient soluble dietary fibre to reduce the laxative effect of the sugar alcohol.

In one embodiment, the dietary fibre in the centrefill comprises one or more soluble hydrocolloids. In a further embodiment, at least one of the one or more soluble hydrocolloids is selected from xanthan gum, pectin, locust bean gum, psyllium, gum arabic and sodium alginate. In yet another embodiment, the dietary fibre is selected from a blend of xanthan gum and locust bean gum, sodium alginate, pectin, a blend of pectin and xanthan gum, and a blend of pectin and gum arabic. In a still further embodiment, the dietary fibre is selected from a blend of pectin and xanthan gum, and a blend of pectin and gum arabic. Where the dietary fibre comprises a blend of xanthan gum and locust bean gum, this blend may contain a ratio of from 4:96 to 12.5:87.5 xanthan gum:locust bean gum. Where the dietary fibre comprises a blend of alginates, this blend may contain from 0:100 to 50:50 low viscosity:high viscosity alginates.

In one embodiment, the centrefilled confectionery composition is substantially sugar-free.

In one embodiment, the centrefilled confectionery composition comprises one or more sugar alcohols. Alternatively or in addition, at least the outer shell layer and/or at least the centrefill may comprise one or more sugar alcohols. The one or more sugar alcohols may be selected from the group consisting of mannitol, sorbitol, hydrogenated isomaltulose, hydrogenated glucose, erythritol, maltitol, lactitol and xylitol.

Centrefilled confectionery compositions are commonly made through co-deposition of appropriate solutions into moulds. Such moulds may be of any type commonly known in the art; for example they may be flexible plastic trays which facilitate the release of the finished confectionery products, or they may be formed as impressions in a starch tray. Co-deposition may be achieved through any suitable method known in the art, such as (but not exclusively) the use of a commercial apparatus (e.g those manufactured by Makat Candy Technology GmbH, Dierdorf, Germany).

Where the centrefill is liquid or semi-liquid in nature, it is important that the centrefill forms in the centre of the confectionery composition. If the centrefill is located towards one edge of the confectionery composition, the relatively thin shell wall at that point may be a point of weakness. Rupture of the outer shell layer can lead to leaking of the centrefill.

The appearance of the shell confectionery and the centrefill may be controlled through use of food colourings, as is known in the art. In particular, it may be preferable for the outer shell layer to be (at least partially) translucent, and the centrefill coloured, so that the centrefill may be seen through the shell layer. It may be particularly desirable for the outer layer to be transparent, colourless, or both, to improve the visibility of the coloured centrefill.

In the following compositions, all references to amounts of ingredients refer to the percentage by weight of the relevant candy composition.

A typical composition of a chewy candy is:
Sucrose or other bulk sweetener in crystalline form—30-60%
Glucose syrup or other bulk sweetener in amorphous form—30-60%
Fat—0-15%
Emulsifying compounds—0-2%
Gelling agent (e.g. gelatin)—up to 6%
Flavours, colours, acid, intense sweeteners—as required

The moisture content of a chewy candy is typically 4-8%.

A typical composition of a jelly (or gummy) candy is:
Sucrose or other bulk sweetener in amorphous form—30-60%
Glucose syrup or other bilk sweetener in amorphous form—30-60%
Gelling agent—up to 10%
Flavours, colours, acid, intense sweeteners—as required

The moisture content of a jelly candy is typically 10-20%.

A typical composition of a hard boiled candy is:
Sucrose or other bulk sweetener in crystalline form—30-60%
Glucose syrup or other bulk sweetener in amorphous form—30-60%
Fat—0-10%
Emulsifying compounds—0-2%
Flavours, colours, acid, intense sweeteners—as required

The moisture content of a hard boiled candy is typically 0.5-6%.

Suitable fats include hydrogenated vegetable oil, hydrogenated palm kernel oil, coconut fat, palm oil, milk fat, cotton seed oil, and cocoa butter. Suitable emulsifiers include sucrose esters, lecithin, polyglyceryl-10 dipalmitate (POLYALDO), polysorbates (TWEENs) and sorbitan fatty acid esters (SPANs), glycerol monostearate, mono- and diglycerides of fatty acids, and polyglycerol polyricinoleate (PGPR).

As used herein, the term ‘bulk sweetener’ has the ordinary meaning in the art, and refers to an ingredient which typically adds both bulk and sweetness to a confectionery composition. In general, bulk sweeteners may be sugar or sugarless. The bulk sweeteners used in the outer shell layer and in the centrefill may be the same or different, and each layer may use one bulk sweetener only, or more than one bulk sweetener. Suitable sugarless bulk sweeteners may include sugar alcohols (hydrogenated saccharides), including erythritol, hydrogenated isomaltuose, lactitol, maltitol, mannitol, sorbitol, xylitol, and hydrogenated starch hydrolysates. In addition, the centrefilled confectionery composition may contain bulk sweeteners such as polydextrose, dextrin, starches resistant to degradation in the human gut (e.g those available under the trade names FIBERSOL-2 from Matsutani, HI-MAIZE from National Stach, ACTISTAR from Cargill), fructo-oligosaccharides, inulin and galacto-oligosaccharides. Sugar sweeneters may include glucose, fructose, sucrose, corn syrup, or maltodextrin. Whilst the use of exclusively sugarless sweeteners is preferred, sugar and sugarless sweeteners may be used in combination, or sugar sweeteners may be used exclusively.

Dietary fibre refers to the indigestible portion of plant food. Although not a direct source of nutrition (being indigestible), the consumption of dietary fibre is believed to be beneficial to health by aiding digestion, and to the suppression of appetite. Dietary fibre may be insoluble or soluble in water, with both soluble and insoluble fibres mixing readily with water.

Soluble dietary fibres including gums, pectins, psyllium and beta-glucans have similar biological effects. Due to their viscosity they delay gastric emptying (Low, 1990; Roberfroid, 1993) and cause an additional expansion of the unstirred layer in the small intestine which further delays digestion and absorption (Blackburn et al, 1992). Thus, in many studies they have been reported to lower postprandial blood glucose in both normal and diabetic subjects (Flammang et al, 2006; Goulder et al 1978; Woolever and Jenkins, 1993). In addition, a sense of satiety may result from the prolonged presence of nutrients in the small intestine (Sepple and Read, 1989; Chow et al, 2006). Through the enhancement of satiety and fecal energy losses some soluble viscous fibres such as glucomannan, may aid in weight management (Keithley and Swanson, 2005, Birketvedt, et al, 2005). Soluble dietary fibres also have effects on cardiovascular risk factors including a lowering of total and LDL cholesterol, triglycerides and blood pressure (Vuksan et al, 1999: Aro et al, 1984; Bosello et al, 1984; Krotkiewski, 1987; Blake et al, 1997).

Particularly suitable soluble fibres for use in the present invention include hydrocolloids such as alginates, xanthan gum, locust bean gum, tara gum, low acyl gellan, agarose, gum arabic etc. Suitable insoluble fibres include salts of carboxymethylcellulose, such as sodium carboxymethylcellulose.

Where the centrefill comprises pectin, it should be kept at temperatures of at least 60° C. to prevent gelation of the centrefill before deposition of the jelly candy composition.

The addition of fibre to the centrefill necessitates a relatively high moisture content to ensure hydration of the fibre. At the same time, the water activity (AW) of the centrefill should be maintained below 0.6 in order to prevent the growth of microbes. This can be done by increasing the content of low molecular weight carbohydrates, such as sorbitol and glycerol, as will be readily understood by the skilled man.

The invention may be better understood by consideration of the following exemplary formulations.

### EXAMPLES A

### Jelly Candy Shell Material (Containing Sugar)

A solution for forming a jelly candy layer was formed as follows:

A gelatin solution was prepared according to Table 1. The water was heated to 60° C., the gelatin was stirred in, and the mixture was covered and kept warm until the gelatin had dissolved (approximately 30 minutes). The resulting solution was stirred well before being used.

TABLE 1
Gelatin solution

| | |
|---|---|
| Gelatin 250 bloom (96% dry solids) | 400 g |
| Water | 600 g |
| Total | 1000 g |

Sugar solutions were prepared according to Table 2.

TABLE 2
Sugar solution

| | 1 | | 2 | | 3 | |
|---|---|---|---|---|---|---|
| Granulated sugar | 295 | g | 275 | g | 293 | g |
| Glucose 63DE | 625 | g | 625 | g | 625 | g |
| Water | 80 | g | 80 | g | 80 | g |
| Modified food starch | 0 | g | 20 | g | 0 | g |
| Pectin | 0 | g | 0 | g | 2 | g |
| Total | 1000 | g | 1000 | g | 1000 | g |

The modified food starch used was that sold as ULTRA-TEX 2 by the National Starch Company. A suitable pectin is sold as GRINDSTED™ Pectin CF 140 B, and is extracted from citrus peel. The pectin has a degree of esterification of 57.5-62%, a maximum setting temperature of 76° C., and a pH in 1% solution of 5.2-5.8.

When present, the starch or pectin were first dispersed in the granulated sugar. All of the ingredients were then boiled together (at approximately 92° C.) until a concentration of 77.8 wt % was achieved, as measured by weight loss during evaporation. The sugar solutions were then mixed with gelatin syrup and citric acid as shown in Table 3.

TABLE 3
Jelly candy containing sugar

| | |
|---|---|
| Sugar syrup | 818.5 g |
| Gelatin solution | 173.5 g |
| 50% Citric acid solution | 8.0 g |
| Total | 1000 g |

### EXAMPLES B

### Jelly Candy Shell Material (Sugar-Free)

A sugar-free syrup was prepared according to Table 4. This syrup was used in place of the sugar solution in the jelly candy of Table 3.

TABLE 4
Sugar-free syrup

| | |
|---|---|
| Lycasin 80/55 | 918 g |
| Water | 80 g |
| Pectin | 2 g |
| Total | 1000 g |

### EXAMPLES C

### Sugar-Free Centrefill Material for Jelly Candy

Sugar-free syrups were prepared according to Tables 5-15. The dietary fibre components were dispersed in the sorbitol (or other sugar alcohol) using a blender, and then the mixture was placed in a saucepan. Water and glycerol were added , together with colouring and sucralose (where present), and the mixture was heated to remove the stated amount of water. Finally, any flavouring (where present) was added.

TABLE 5
Sugar-free centrefill

| | 1 | | 2 | |
|---|---|---|---|---|
| Sorbitol P60 | 150 | g | 150 | g |
| Water | 100 | g | 100 | g |
| Glycerol | 12.5 | g | 12.5 | g |
| Xanthan gum | 12.5 | g | 0 | g |
| Pectin | 0 | g | 12.5 | g |
| Total before evaporation | 275 | g | 275 | g |
| Amount of water to be evaporated | 25 | g | 25 | g |

TABLE 6
Sugar-free centrefill

| | 3 | | 4 | |
|---|---|---|---|---|
| Sorbitol P60 | 150 | g | 150 | g |
| Water | 94.25 | g | 94.25 | g |
| Glycerol | 12.5 | g | 12.5 | g |
| Xanthan gum | 12.5 | g | 0 | g |
| Pectin | 0 | g | 12.5 | g |
| Sucralose solution 1% | 3.75 | g | 3.75 | g |
| Citric acid solution 50% | 2.0 | g | 2.0 | g |
| Flavour: Lemon 511247 | 0.03 | g | 0.03 | g |
| Colour: lemon yellow | 0.03 | g | 1.25 | g |
| Total before evaporation | 275.05 | g | 276.28 | g |
| Amount of water to be evaporated | 27 | g | 27 | g |

TABLE 7
Sugar-free centrefill

| | 5 | | 6 | | 7 | | 8 | | 9 | | 10 | |
|---|---|---|---|---|---|---|---|---|---|---|---|---|
| Sorbitol P60 | 300 | g | 300 | g | 311.5 | g | 537 | g | 299 | g | 272.5 | g |
| Water | 188.5 | g | 188.5 | g | 188.5 | g | 377 | g | 188.5 | g | 188.5 | g |
| Glycerol | 25 | g | 25 | g | 25 | g | 50 | g | 25 | g | 25 | g |
| Xanthan gum | 25 | g | 0 | g | 13.50 | g | 0 | g | 15 | g | 0 | g |
| Pectin | 0 | g | 25 | g | 0 | g | 113 | g | 15 | g | 56.5 | g |
| Sucralose | 7.5 | g | 7.5 | g | 7.5 | g | 15 | g | 7.5 | g | 7.5 | g |
| solution 1% | | | | | | | | | | | | |
| Citric acid | 4 | g | 4 | g | 4 | g | 8 | g | 0 | g | 0 | g |
| solution 50% | | | | | | | | | | | | |
| Flavour: Lemon | 0.05 | g | 0.05 | g | 0.05 | g | 0.1 | g | 0.05 | g | 0.05 | g |
| 511247 | | | | | | | | | | | | |
| Red colour | 0.05 | g | 0.05 | g | 0.05 | g | 0.1 | g | 0.05 | g | 0.05 | g |
| Yellow colour | 0.05 | g | 0.05 | g | 0.05 | g | 0.1 | g | 0.05 | g | 0.05 | g |
| Total before | 550.15 | g | 550.15 | g | 550.15 | g | 1100.30 | g | 550.15 | g | 550.15 | g |
| evaporation | | | | | | | | | | | | |
| Amount of water | 100 | g | 100 | g | 100 | g | 100 | g | 100 | g | 100 | g |
| evaporated | | | | | | | | | | | | |

TABLE 8
Sugar-free centrefill

| | 11 | | 12 | | 13 | | 14 | |
|---|---|---|---|---|---|---|---|---|
| Sorbitol P60 | 75 | g | 75 | g | 75 | g | 75 | g |
| Water | 50 | g | 50 | g | 50 | g | 50 | g |
| Glycerol | 6.25 | g | 6.25 | g | 6.25 | g | 6.25 | g |
| Xanthan gum | 5 | g | 1.25 | g | 5 | g | 1.25 | g |
| Pectin | 1.25 | g | 5 | g | 0 | g | 0 | g |
| Locust bean gum | 0 | g | 0 | g | 1.25 | g | 5 | g |
| Total before | 137.5 | g | 137.5 | g | 137.5 | g | 137.5 | g |
| evaporation | | | | | | | | |
| Amount of water | 12.5 | g | 12.5 | g | 12.5 | g | 12.5 | g |
| evaporated | | | | | | | | |

TABLE 9
Sugar-free centrefill

| | 15 | | 16 | | 17 | | 18 | |
|---|---|---|---|---|---|---|---|---|
| Sorbitol P60 | 75 | g | 75 | g | 75 | g | 75 | g |
| Water | 50 | g | 50 | g | 50 | g | 50 | g |
| Glycerol | 6.25 | g | 6.25 | g | 6.25 | g | 6.25 | g |
| Xanthan gum | 5 | g | 1.25 | g | 5 | g | 1.25 | g |
| Sodium | 1.25 | g | 5 | g | 0 | g | 0 | g |
| carboxymethyl- | | | | | | | | |
| cellulose | | | | | | | | |
| Gum arabic | 0 | g | 0 | g | 1.25 | g | 5 | g |
| Total before | 137.5 | g | 137.5 | g | 137.5 | g | 137.5 | g |
| evaporation | | | | | | | | |
| Amount of water | 12.5 | g | 12.5 | g | 12.5 | g | 12.5 | g |
| evaporated | | | | | | | | |

TABLE 10
Sugar-free centrefill

| | 19 | | 20 | | 21 | | 22 | |
|---|---|---|---|---|---|---|---|---|
| Sorbitol P60 | 75 | g | 75 | g | 75 | g | 75 | g |
| Water | 50 | g | 50 | g | 50 | g | 50 | g |
| Glycerol | 6.25 | g | 6.25 | g | 6.25 | g | 6.25 | g |
| Xanthan gum | 5 | g | 1.25 | g | 5 | g | 1.25 | g |
| Gellan | 1.25 | g | 5 | g | 0 | g | 0 | g |
| Agarose | 0 | g | 0 | g | 1.25 | g | 5 | g |
| Total before | 137.5 | g | 137.5 | g | 137.5 | g | 137.5 | g |
| evaporation | | | | | | | | |
| Amount of water | 12.5 | g | 12.5 | g | 12.5 | g | 12.5 | g |
| evaporated | | | | | | | | |

TABLE 11
Sugar-free centrefill

| | 23 | | 24 | | 25 | | 26 | |
|---|---|---|---|---|---|---|---|---|
| Sorbitol P60 | 75 | g | 75 | g | 75 | g | 75 | g |
| Water | 50 | g | 50 | g | 49 | g | 49 | g |
| Glycerol | 6.25 | g | 6.25 | g | 6.25 | g | 6.25 | g |
| Pectin (high | 6.25 | g | 0 | g | 6.25 | g | 0 | g |
| methoxy) | | | | | | | | |
| Pectin (low | 0 | g | 6.25 | g | 0 | g | 6.25 | g |
| methoxy) | | | | | | | | |
| Citric acid | 0 | g | 0 | g | 1 | g | 1 | g |
| solution 50% | | | | | | | | |
| Total before | 137.5 | g | 137.5 | g | 137.5 | g | 137.5 | g |
| evaporation | | | | | | | | |
| Amount of water | 12.5 | g | 12.5 | g | 12.5 | g | 12.5 | g |
| evaporated | | | | | | | | |

TABLE 12
Sugar-free centrefill

| | 27 | | 28 | | 29 | | 30 | |
|---|---|---|---|---|---|---|---|---|
| Sorbitol P60 | 75 | g | 75 | g | 75 | g | 75 | g |
| Water | 50 | g | 50 | g | 50 | g | 50 | g |
| Glycerol | 6.25 | g | 6.25 | g | 6.25 | g | 6.25 | g |
| Xanthan gum | 2.5 | g | 3.75 | g | 0 | g | 1.25 | g |
| Alginate | 0 | g | 0 | g | 6.25 | g | 5 | g |
| Grindsted | | | | | | | | |
| FD155 | | | | | | | | |
| Pectin | 0 | g | 5 | g | 1.25 | g | 5 | g |
| Locust bean gum | 3.75 | g | 2.5 | g | 0 | g | 1.25 | g |
| Total before | 137.5 | g | 142.5 | g | 137.5 | g | 138.75 | g |
| evaporation | | | | | | | | |
| Amount of water | 12.5 | g | 12.5 | g | 12.5 | g | 12.5 | g |
| evaporated | | | | | | | | |

TABLE 13
Sugar-free centrefill

| | 31 | | 32 | | 33 | | 34 | |
|---|---|---|---|---|---|---|---|---|
| Sorbitol P60 | 75 | g | 75 | g | 75 | g | 75 | g |
| Water | 50 | g | 50 | g | 50 | g | 50 | g |
| Glycerol | 6.25 | g | 6.25 | g | 6.25 | g | 6.25 | g |
| Xanthan gum | 0.19 | g | 0 | g | 0.63 | g | 1.88 | g |
| Alginate | 0.63 | g | 2.50 | g | 0 | g | 0 | g |
| Grindsted | | | | | | | | |
| FD155 | | | | | | | | |
| Locust bean gum | 5.5 | g | 3.75 | g | 5.63 | g | 4.38 | g |
| Total before | 137.56 | g | 137.5 | g | 137.5 | g | 137.5 | g |
| evaporation | | | | | | | | |
| Amount of water | 12.5 | g | 12.5 | g | 12.5 | g | 12.5 | g |
| evaporated | | | | | | | | |

TABLE 14
Sugar-free centrefill

| | 35 | 36 |
|---|---|---|
| Sorbitol P60 | 75 g | 75 g |
| Water | 50 g | 50 g |
| Glycerol | 6.25 g | 6.25 g |
| Xanthan gum | 0.31 g | 0.63 g |
| Locust bean gum | 5.94 g | 5.63 g |
| Sodium | 0 g | 1.25 g |
| carboxymethyl- | | |
| cellulose | | |
| Total before | 137.5 g | 138.75 g |
| evaporation | | |
| Amount of water | 12.5 g | 12.5 g |
| evaporated | | |

TABLE 15
Sugar-free centrefill

| | 37 | | 38 | | 39 | | 40 | | 41 | |
|---|---|---|---|---|---|---|---|---|---|---|
| Sorbitol P60 | 75 | g | 0 | g | 87.5 | g | 87.5 | g | 81.25 | g |
| Maltitol P90 | 0 | g | 25 | g | 0 | g | 0 | g | 0 | g |
| Lycasin 80/55 | 0 | g | 50 | g | 0 | g | 0 | g | 0 | g |
| Water | 50 | g | 37.5 | g | 37.5 | g | 50 | g | 50 | g |
| Glycerol | 6.25 | g | 6.25 | g | 6.25 | g | 6.25 | g | 6.25 | g |
| Xanthan gum | 0.31 | g | 0.31 | g | 0.31 | g | 0.31 | g | 0.31 | g |
| Locust bean gum | 5.94 | g | 5.94 | g | 5.94 | g | 5.94 | g | 5.94 | g |
| Flavour: Lemon | 0.01 | g | 0 | g | 0 | g | 0 | g | 0 | g |
| 511247 | | | | | | | | | | |
| Colour: Red CC-5000- | 0.01 | g | 0.01 | g | 0 | g | 0 | g | 0 | g |
| L-P | | | | | | | | | | |
| Sucralose | 1.88 | g | 0 | g | 0 | g | 0 | g | 0 | g |
| solution 1% | | | | | | | | | | |
| Total before | 139.4 | g | 125.01 | g | 137.5 | g | 150 | g | 143.75 | g |
| evaporation | | | | | | | | | | |
| Amount of water | 12.5 | g | 9.38 | g | 9.38 | g | 12.5 | g | 12.5 | g |
| evaporated | | | | | | | | | | |

Further sugar-free syrups were prepared according to Tables 16-32. The dietary fibre components were dispersed in the sorbitol (or other sugar alcohol) using a blender, and then the mixture was placed in a saucepan. Water and glycerol were added, together with colouring and sucralose (where present), and the mixture was heated to remove the stated amount of water. Finally, any flavouring and acid (where present) were added.

TABLE 16
Sugar-free centrefill

| | 42 | | 43 | | 44 | | 45 | | 46 | |
|---|---|---|---|---|---|---|---|---|---|---|
| Sorbitol P60 | 81.25 | g | 81.25 | g | 81.25 | g | 100 | g | 106.25 | g |
| Water | 43.75 | g | 43.75 | g | 43.75 | g | 25 | g | 18.75 | g |
| Glycerol | 6.25 | g | 6.25 | g | 6.25 | g | 6.25 | g | 6.25 | g |
| Xanthan gum | 5.75 | g | 5.75 | g | 5.75 | g | 6.25 | g | 6.25 | g |
| Starch Novation Prima | 2.5 | g | 0 | g | 0 | g | 0 | g | 0 | g |
| Starch N-Lite D | 0 | g | 2.5 | g | 0 | g | 0 | g | 0 | g |
| Starch N-Creamer | 0 | g | 0 | g | 2.5 | g | 0 | g | 0 | g |
| Locust bean gum | 0 | g | 0 | g | 0 | g | 3.75 | g | 3.75 | g |
| Total before | 139.5 | g | 137 | g | 137 | g | 135.75 | g | 135.75 | g |
| evaporation | | | | | | | | | | |
| Amount of water | 14.5 | g | 14.24 | g | 14.24 | g | 10.75 | g | 10.75 | g |
| evaporated | | | | | | | | | | |

TABLE 17
Sugar-free centrefill

| | 47 | | 48 | |
|---|---|---|---|---|
| Sorbitol P60 | 75 | g | 75 | g |
| Water | 45 | g | 45 | g |
| Glycerol | 6.25 | g | 6.25 | g |
| Pectim LM | 12.74 | g | 0 | g |
| Pectin slow set | 0 | g | 12.74 | g |
| Citric acid | 1 | g | 1 | g |
| solution 50% | | | | |
| Total before | 139.99 | g | 139.99 | g |
| evaporation | | | | |
| Amount of water | 14.99 | g | 14.99 | g |
| evaporated | | | | |

TABLE 18
Sugar-free centrefill

| | 49 | | 50 | | 51 | |
|---|---|---|---|---|---|---|
| Sorbitol P60 | 75 | g | 78.34 | g | 80.74 | g |
| Water | 45 | g | 45 | g | 45 | g |
| Glycerol | 6.25 | g | 6.25 | g | 6.25 | g |
| Pectin slow set | 12.74 | g | 9.40 | g | 7 | g |
| Citric acid | 0.5 | g | 0.5 | g | 0.5 | g |
| solution 50% | | | | | | |
| Total before | 139.49 | g | 139.49 | g | 139.49 | g |
| evaporation | | | | | | |
| Amount of water | 14.49 | g | 14.49 | g | 14.49 | g |
| evaporated | | | | | | |

TABLE 19
Sugar-free centrefill

| | 52 | | 53 | | 54 | |
|---|---|---|---|---|---|---|
| Sorbitol P60 | 79.78 | g | 81.86 | g | 83.36 | g |
| Maltitol P35 | 10 | g | 10 | g | 10 | g |
| Water | 35 | g | 35 | g | 35 | g |
| Glycerol | 6.25 | g | 6.25 | g | 6.25 | g |
| Pectin slow set | 7.96 | g | 5.88 | g | 3.50 | g |
| Citric acid | 1 | g | 1 | g | 1 | g |
| solution 50% | | | | | | |
| Total before | 139.99 | g | 139.99 | g | 139.99 | g |
| evaporation | | | | | | |
| Amount of water | 14.99 | g | 14.99 | g | 14.99 | g |
| evaporated | | | | | | |

TABLE 20
Sugar-free centrefill

| | 55 | | 56 | | 57 | | 58 | |
|---|---|---|---|---|---|---|---|---|
| Sorbitol P60 | 75 | g | 77.09 | g | 75 | g | 75 | g |
| Water | 45 | g | 45 | g | 45 | g | 45 | g |
| Glycerol | 6.25 | g | 6.25 | g | 6.25 | g | 6.25 | g |
| Alginate | 0 | g | 0 | g | 0 | g | 7.71 | g |
| Manucol LD | | | | | | | | |
| (low viscosity) | | | | | | | | |
| Alginate | 7.71 | g | 5.63 | g | 0 | g | 0 | g |
| Manucol DM | | | | | | | | |
| (high viscosity) | | | | | | | | |
| Alginate | 0 | g | 0 | g | 7.71 | g | 0 | g |
| Manugel GMB | | | | | | | | |
| (medium | | | | | | | | |
| viscosity) | | | | | | | | |
| Citric acid | 0.5 | g | 0.5 | g | 0.5 | g | 0.5 | g |
| solution 50% | | | | | | | | |
| Total before | 134.46 | g | 134.46 | g | 134.46 | g | 134.46 | g |
| evaporation | | | | | | | | |
| Amount | 9.46 | g | 9.46 | g | 9.46 | g | 9.46 | g |
| of water | | | | | | | | |
| evaporated | | | | | | | | |

TABLE 21
Sugar-free centrefill

| | 59 | | 60 | | 61 | | 62 | |
|---|---|---|---|---|---|---|---|---|
| Sorbitol P60 | 75 | g | 75 | g | 75 | g | 75 | g |
| Water | 45 | g | 45 | g | 45 | g | 45 | g |
| Glycerol | 6.25 | g | 6.25 | g | 6.25 | g | 6.25 | g |
| Alginate | 6.25 | g | 5 | g | 5 | g | 5 | g |
| Manucol LD | | | | | | | | |
| (low viscosity) | | | | | | | | |
| Alginate | 1.46 | g | 2.71 | g | 0 | g | 2.71 | g |
| Manucol DM | | | | | | | | |
| (high viscosity) | | | | | | | | |
| Locust bean | 0 | g | 0 | g | 2.71 | g | 2.71 | g |
| gum | | | | | | | | |
| Citric acid | 0.5 | g | 0.5 | g | 0.5 | g | 0.5 | g |
| solution 50% | | | | | | | | |
| Total before | 134.46 | g | 134.46 | g | 134.46 | g | 134.46 | g |
| evaporation | | | | | | | | |
| Amount | 9.46 | g | 9.46 | g | 9.46 | g | 11.93 | g |
| of water | | | | | | | | |
| evaporated | | | | | | | | |

TABLE 22
Sugar-free centrefill

| | 63 | | 64 | | 65 | | 66 | |
|---|---|---|---|---|---|---|---|---|
| Sorbitol P60 | 75 | g | 75 | g | 75 | g | 80.21 | g |
| Water | 45 | g | 45 | g | 45 | g | 45 | g |
| Glycerol | 6.25 | g | 6.25 | g | 6.25 | g | 6.25 | g |
| Alginate | 2.71 | g | 3.85 | g | 3.85 | g | 0 | g |
| Manucol LD | | | | | | | | |
| (low viscosity) | | | | | | | | |
| Alginate | 5 | g | 3.85 | g | 3.85 | g | 2.5 | g |
| Manucol DM | | | | | | | | |
| (high viscosity) | | | | | | | | |
| Locust bean | 2.71 | g | 2.5 | g | 0 | g | 0 | g |
| gum | | | | | | | | |
| Citric acid | 0.5 | g | 0.5 | g | 0.5 | g | 0.5 | g |
| solution 50% | | | | | | | | |
| Total before | 137.18 | g | 136.95 | g | 134.45 | g | 134.46 | g |
| evaporation | | | | | | | | |
| Amount | 12.18 | g | 11.95 | g | 9.45 | g | 9.46 | g |
| of water | | | | | | | | |
| evaporated | | | | | | | | |

TABLE 23
Sugar-free centrefill

| | 67 | |
|---|---|---|
| Sorbitol P60 | 325 | g |
| Water | 175 | g |
| Glycerol | 25 | g |
| Xanthan gum | 10 | g |
| Starch N-Creamer | 10 | g |
| (National Starch) | | |
| Total before | 535 | g |
| evaporation | | |
| Amount of water | 44.17 | g |
| evaporated | | |

TABLE 24
Sugar-free centrefill

| | 68 | | 69 | | 70 | | 71 | |
|---|---|---|---|---|---|---|---|---|
| Sorbitol P60 | 80 | g | 79.38 | g | 78.75 | g | 78.13 | g |
| Water | 45 | g | 45 | g | 45 | g | 45 | g |
| Glycerol | 6.25 | g | 6.25 | g | 6.25 | g | 6.25 | g |
| Alginate Manucol DM | 3.75 | g | 4.38 | g | 5 | g | 5.63 | g |
| (high viscosity) | | | | | | | | |
| Citric acid solution | 0.5 | g | 0.5 | g | 0.5 | g | 0.5 | g |
| 50% | | | | | | | | |
| Total before | 135.5 | g | 135.5 | g | 135.5 | g | 135.5 | g |
| evaporation | | | | | | | | |
| Amount of water | 10.5 | g | 10.5 | g | 10.5 | g | 10.5 | g |
| evaporated | | | | | | | | |

TABLE 25
Sugar-free centrefill

| | 72 | | 73 | | 74 | | 75 | |
|---|---|---|---|---|---|---|---|---|
| Sorbitol P60 | 80 | g | 79.38 | g | 78.75 | g | 78.13 | g |
| Water | 45 | g | 45 | g | 45 | g | 45 | g |
| Glycerol | 6.25 | g | 6.25 | g | 6.25 | g | 6.25 | g |
| Alginate Manucol DM | 3.75 | g | 4.38 | g | 5 | g | 5.63 | g |
| (high viscosity) | | | | | | | | |
| Citric acid solution | 0.5 | g | 0.5 | g | 0.5 | g | 0.5 | g |
| 50% | | | | | | | | |
| Total before | 135.5 | g | 135.5 | g | 135.5 | g | 135.5 | g |
| evaporation | | | | | | | | |
| Amount of water | 10.5 | g | 10.5 | g | 10.5 | g | 10.5 | g |
| evaporated | | | | | | | | |

TABLE 26
Sugar-free centrefill

| | 76 | | 77 | | 78 | |
|---|---|---|---|---|---|---|
| Sorbitol P60 | 78.13 | g | 77.25 | g | 79.91 | g |
| Water | 45 | g | 45 | g | 45 | g |
| Glycerol | 6.25 | g | 6.25 | g | 6.25 | g |
| Alginate Manucol LD | 1.25 | g | 2.5 | g | 0 | g |
| (low viscosity) | | | | | | |
| Alginate Manucol DM | 4.38 | g | 4 | g | 3.21 | g |
| (high viscosity) | | | | | | |
| Locust bean gum | 0 | g | 0 | g | 0.63 | g |
| Citric acid solution | 0.5 | g | 0.5 | g | 0.5 | g |
| 50% | | | | | | |
| Total before | 135.5 | g | 135.5 | g | 135.5 | g |
| evaporation | | | | | | |
| Amount of water | 10.5 | g | 10.5 | g | 10.5 | g |
| evaporated | | | | | | |

TABLE 27
Sugar-free centrefill

| | 79 | | 80 | | 81 | |
|---|---|---|---|---|---|---|
| Sorbitol P60 | 76.03 | g | 81.25 | g | 79.38 | g |
| Water | 45 | g | 45 | g | 45 | g |
| Glycerol | 6.25 | g | 6.25 | g | 6.25 | g |
| Xanthan gum | 0.31 | g | 0.31 | g | 0.31 | g |
| Locust bean gum | 7.41 | g | 2.19 | g | 4.06 | g |
| Citric acid solution | 0.5 | g | 0.5 | g | 0.5 | g |
| 50% | | | | | | |
| Total before | 135.5 | g | 135.5 | g | 135.5 | g |
| evaporation | | | | | | |
| Amount of water | 10.5 | g | 10.5 | g | 10.5 | g |
| evaporated | | | | | | |

TABLE 28
Sugar-free centrefill

| | 82 | | 83 | |
|---|---|---|---|---|
| Sorbitol P60 | 78.13 | g | 80.54 | g |
| Water | 45 | g | 45 | g |
| Glycerol | 6.25 | g | 6.25 | g |
| Xanthan gum | 0.31 | g | 0.31 | g |
| Locust bean gum | 5.31 | g | 2.9 | g |
| Citric acid solution | 0.5 | g | 0.5 | g |
| 50% | | | | |
| Total before | 135.5 | g | 135.5 | g |
| evaporation | | | | |
| Amount of water | 10.5 | g | 10.5 | g |
| evaporated | | | | |

TABLE 29
Sugar-free centrefill

| | 84 | | 85 | | 86 | | 87 | |
|---|---|---|---|---|---|---|---|---|
| Maltitol P90 | 29.38 | g | 16.88 | g | 29.38 | g | 29.38 | g |
| Lycasin 80/55 | 66.66 | g | 79.16 | g | 0 | g | 0 | g |
| Polydextrose syrup | 0 | g | 0 | g | 0 | g | 66.66 | g |
| Lycasin HBC | 0 | g | 0 | g | 66.66 | g | 0 | g |
| Water | 28.34 | g | 28.34 | g | 28.34 | g | 28.34 | g |
| Glycerol | 6.25 | g | 6.25 | g | 6.25 | g | 6.25 | g |
| Alginate Manucol DM | 4.38 | g | 4.38 | g | 4.38 | g | 4.38 | g |
| (high viscosity) | | | | | | | | |
| Citric acid solution | 0.5 | g | 0.5 | g | 0.5 | g | 0.5 | g |
| 50% | | | | | | | | |
| Total before | 135.5 | g | 135.5 | g | 135.5 | g | 135.5 | g |
| evaporation | | | | | | | | |
| Amount of water | 10.5 | g | 10.5 | g | 10.5 | g | 10.5 | g |
| evaporated | | | | | | | | |

TABLE 30
Sugar-free centrefill

| | 88 | | 89 | |
|---|---|---|---|---|
| Maltitol P90 | 16.88 | g | 16.88 | g |
| Maltitol syrup (Lycasin 80/55) | 79.16 | g | 79.16 | g |
| Water | 28.34 | g | 28.34 | g |
| Glycerol | 6.25 | g | 6.25 | g |
| Carrageenan | 6.25 | g | 1.88 | g |
| Xanthan gum | 1.46 | g | 0.63 | g |
| Citric acid solution 50% | 0.5 | g | 0.5 | g |
| Total before evaporation | 138.84 | g | 133.63 | g |
| Amount of water evaporated | 13.84 | g | 8.63 | g |

TABLE 31
Sugar-free centrefill

| | 90 | | 91 | | 92 | | 93 | |
|---|---|---|---|---|---|---|---|---|
| Sorbitol P60 | 83.13 | g | 83.13 | g | 78.13 | g | 78.13 | g |
| Water | 40 | g | 40 | g | 40 | g | 40 | g |
| Glycerol | 6.25 | g | 6.25 | g | 6.25 | g | 6.25 | g |
| Medium density wheat fibre | 7.5 | g | 0 | g | 0 | g | 0 | g |
| (Vitacel WF 1000) | | | | | | | | |
| High density wheat fibre (Vitacel | 0 | g | 7.5 | g | 3.75 | g | 6.25 | g |
| WF 101) | | | | | | | | |
| Sodium carboxymethylcellulose | 0 | g | 0 | g | 3.75 | g | 1.56 | g |
| (Cekol CMC 50,000) | | | | | | | | |
| Citric acid solution 50% | 0.5 | g | 0.5 | g | 0.5 | g | 0.5 | g |
| Total before evaporation | 137.38 | g | 137.38 | g | 132.38 | g | 132.69 | g |
| Amount of water evaporated | 12.38 | g | 12.38 | g | 7.38 | g | 7.69 | g |

TABLE 32
Sugar-free centrefill

| | 94 | |
|---|---|---|
| Sorbitol P60 | 78.13 | g |
| Water | 40 | g |
| Glycerol | 6.25 | g |
| High density wheat fibre (Vitacel | 7.5 | g |
| WF 101) | | |
| Alginate Manucol DM (high | 3.75 | g |
| viscosity) | | |
| Citric acid solution 50% | 0.5 | g |
| Total before evaporation | 136.13 | g |
| Amount of water evaporated | 11.13 | g |

Sugar-free syrups 1 to 94 of Tables 5 to 32 were prepared and assessed for suitability for inclusion in a centrefilled confectionery composition.

### EXAMPLES D

### Hard Boil

1. Hard Boil Sugar Free Formulation for the Shell:

Moisture 1.5%

Fat 5%

Colour, flavour, intense sweetener, acid, qs

Isomalt or hydrogenated glucose syrup to 100%

2. For the Filling:

Formulation A
Pectin Low Methoxy 5%
Glycerol 7.5%
Citric acid 1%
Moisture 8%
Colour, flavour, intense sweetener, qs
Maltitol to 100%

Formulation B
Xanthan Gum 2%
Glycerol 8%
Citric acid 1%
Moisture 2-15%
Colour, flavour, intense sweetener, qs
Hydrogenated glucose syrup) to 100%

Formulation C
Alginate 2.5%
Glycerol 7%
Colour, flavour, intense sweetener, qs
Citric acid 1%
Moisture 8%
Maltitol to 100%

After making up, the above formulations are boiled to reduce the moisture content so as to prevent the hard boil going soft over time.

### EXAMPLES E

### Chew

1. Sugar Free Chew Formulation for the Shell:
crystalline maltitol 45%
Fat 7%
Emulsifying compounds 1%
Gelatine 3%
Colour, flavour, intense sweetener, qs
Citric acid 1%
amorphous polydextrose to 100%

2. For the Filling:

Formulation A
Pectin High Methoxy 10%
Glycerol 7%
Colour, flavour, intense sweetener, qs
Citric acid 1%
Moisture 8%
hydrogenated glucose syrup to 100%

Formulation B
Xanthan Gum 5%
Glycerol 7%
Colour, flavour, intense sweetener, qs
Citric acid 1%
Moisture 8%
maltitol to 100%

Formulation C
Alginate (High Viscosity) 6%
Glycerol 8%
Colour, flavour, intense sweetener, qs
Citric acid 1%
Moisture 8%
maltitol to 100%

Formulation D
Alginate (Low Viscosity) with Xanthan 50:50 5%
Glycerol 7%
Colour, flavour, intense sweetener, qs
Citric acid 1%
Moisture 8%
hydrogenated glucose syrup to 100%

### EXAMPLES F

### Chew

1. Maltitol-Based Sugar-Free Chew Material

Polydextrose (LITESSE ULTRA available from Danisco Sweeteners Ltd, Redhill, UK) (96 wt % aqueous solution, 1.87 kg, giving 1.80 kg dry solids), water (0.94 kg), lecithin (10 g), maltitol (99% dry solids, 1.63 kg, giving 1.62 kg dry solids), sucrose ester (DUB SE 5S available from Stearinerie Dubois, Boulogne, France) (10 g) and copra fat (0.28 kg) were mixed to form an emulsion and cooked. The mixture was then cooled on a cold table, and mixed with gelatin solution (0.20 kg, 80 g dry solids) in a Z-blade mixer. Further maltitol (0.181 kg, 0.180 kg dry solids) was added and mixed into the dough, followed by vanilla flavouring (18 g).

The final dough was then rolled into a sheet for use in forming the centre-filled chew.

2. Pectin/Gum Arabic-Based Filling Material

Pectin (11.40 kg, 90wt % dry solids, giving 10.26 g dry solids) was dispersed in sorbitol (83.33 kg). The mixture was placed in a saucepan containing water (65 kg), glycerol (12.50 kg), and maltitol syrup (LYCASIN 80/55, available from Roquettes Frères, Lestrem, France) (37 kg, 31.45 kg dry solids), and the mixture was heated to remove 31 kg of water. The mixture was then cooled to around 100° C., and a mixture of gum Arabic (31.30 kg, 28.17 kg dry solids) and sorbitol (41.67 kg) was added with mixing. Finally, raspberry flavouring (1.20 kg), colouring (1 kg, 0.05 kg dry solids) and citric acid (3 kg, 1.65 kg dry solids) were added to the mixture.

3. Formation of the Chew

The chew material of Example 1 was formed into a runnel, and the filling material of Example 2 was deposited into the runnel in an amount to give a proportion of 20 wt % filling in the final chew. The chew sheet was rolled around the filling to form a rope which was then cut into individual pieces.

4. Pectin/Xanthan Gum-Based Filling Material

Pectin (9.50 kg, 8.55 kg dry solids) was dispersed in sorbitol (62.5 kg) and the mixture was placed in a saucepan containing water (80 kg), glycerol (10.40 kg) and maltitol syrup (LYCASIN 80/55, as above) (30.09 kg, 25.58 kg dry solids). The mixture was boiled for 1-2 minutes to dissolve the pectin. A mixture of xanthan gum (0.50 kg, 0.43 kg dry solids) and sorbitol (62.5 kg) was then added with mixing and the mixture was then heated to remove 47.2 kg of water. Finally, colouring (1 kg, 0.05 kg dry solids), raspberry flavouring (1 kg) and citric acid (2.5 kg, 1.375 kg dry solids) were added.

5. Pectin/Xanthan Gum-Based Filling Material

Pectin (9.50 kg, 8.55 kg dry solids) was dispersed in sorbitol (50.65 kg) and the mixture was placed in a saucepan containing water (80 kg), glycerol (8.40 kg) and maltitol syrup (LYCASIN 80/55, as above) (60.18 kg, 51.15 kg dry solids). The mixture was boiled for 1-2 minutes to dissolve the pectin. A mixture of xanthan gum (0.50 kg, 0.43 kg dry solids) and sorbitol (50.65 kg) was then added with mixing and the mixture was then heated to remove 51.7 kg of water. Finally, colouring (1 kg, 0.05 kg dry solids), raspberry flavouring (1 kg) and citric acid (2.5 kg, 1.375 kg dry solids) were added.

6. Formation of the Chew

Each of the fillings of Examples 4 and 5 was used to make a centre-filled chew in the manner described in Example 3, with the exception that the proportions of filling used were 50 wt % of the final chew.

### EXAMPLES G

### Hard Boiled Candy

1. Sugar Free Hard Boiled Candy

Acesulfame K (0.16 kg) was dispersed in isomalt (300.2 kg, 291.20 kg dry solids) and the mixture placed in a saucepan with water (100.1 kg). Maltitol syrup (LYCASIN HBC, available from Roquettes Frères as above) (99.7 kg, 72.81 kg dry solids) was added and the mixture heated to remove 124.9 kg water. Finally, yellow colouring (0.20 kg, 0.01 kg dry weight), citric acid (3.63 kg) and neo citrosa P10 (0.22 kg) and tropical mix (1.44 kg) flavourings were added.

2. Sugar Free Hard Boiled Candy

Acesulfame K (0.16 kg) was dispersed in isomalt (375.0 kg, 363.76 kg dry solids) and the mixture placed in a saucepan with water (125.0 kg). The resulting mixture was heated to remove 125.2 kg water. Finally, yellow colouring (0.20 kg, 0.01 kg dry weight), citric acid (3.65 kg) and neo citrosa P10 (0.22 kg) and tropical mix (1.46 kg) flavourings were added.

3. Filling Material

Pectin (11.00 kg, 9.90 kg dry solids) was dispersed in sorbitol (83.33 kg) and the mixture added to a saucepan containing water (65.00 kg), glycerol (12.00 kg) and maltitol syrup (LYCASIN 80/55, as above) (35.00 kg, 29.75 kg dry solids). The resulting mixture was heated to remove 35.80 kg water, and then cooled to around 100° C. Finally, colour (1.00 kg, 0.05 kg dry solids), raspberry flavour (1.20 kg) and citric acid (3.00 kg, 1.65 kg dry solids) were added.

4. Manufacture of Centrefilled Hard Boiled Candy

For each of the hard boiled candy recipes (Examples 1 and 2), a layer of hot candy syrup (130° C.) was deposited in the base of a mould cavity, a portion of filling was deposited on top of the layer of candy syrup, and the remainder of the mould cavity was then filled with further hot candy syrup. Following cooling, the hard boiled candy composition was released from the mould in the usual manner.

1. A jelly candy composition or a chewy candy composition having a centrefill comprising at least 1% by weight dietary fibre and an outer jelly candy or chewy candy layer encasing the centrefill, wherein the outer jelly candy or chewy candy layer comprises gelatin and is substantially free of dietary fibre.

2. The jelly candy composition or chewy candy composition of claim 1, wherein the centrefill comprises between 1 and 15% by weight soluble dietary fibre.

3. The jelly candy composition or chewy candy composition of claim 1, wherein the dietary fibre comprises one or more soluble hydrocolloids.

4. The jelly candy composition or chewy candy composition of claim 1, wherein the jelly candy composition or chewy candy composition is substantially sugar-free.

5. A hard boiled candy composition having a centrefill comprising at least 1% by weight dietary fibre and an outer hard boiled candy layer encasing the centrefill, wherein the outer hard boiled candy layer is substantially free of dietary fibre.

6. The hard-boiled candy composition of claim 5, wherein the centrefill comprises between 1 and 15% by weight soluble dietary fibre.

7. A centrefilled confectionary composition comprising one or more sugar alcohols, and further comprising a centrefill comprising dietary fibre in an amount effective to offset a laxative effect of the one or more sugar alcohols.

8. A centrefilled confectionery composition comprising at least 20% by weight of centrefill, wherein the centrefill comprises at least 1% by weight of dietary fibre.

9. The centrefilled confectionery composition of claim 8, wherein the centrefill is present in an amount of at least 30% by weight of the confectionery composition.

10. The centrefilled confectionery composition of claim 9, wherein the centrefill is present in an amount of at least 40% by weight of the confectionery composition.

11. The centrefilled confectionery composition of claim 10, wherein the centrefill is present in an amount of at least 50% by weight of the confectionery composition.

12. A centrefilled confectionery composition comprising a centrefill syrup, and further comprising an amount of dietary fibre in the centrefill syrup effective to improve the product integrity of the centrefilled confectionery composition.

13. A method for manufacturing a centrefilled confectionery composition, comprising
preparing separately a first syrup which is substantially free of dietary fibre, and a second syrup comprising dietary fibre, and
co-depositing the first and second syrups into a mould cavity such that on cooling the first syrup forms a shell extending around the inner surface of the mould cavity and containing the second syrup.

14. The method of claim 13, wherein the second syrup comprises between 1 and 15% dietary fibre.
